(19) United States
(12) Patent Application Publication
(10) Pub. No.: US 2013/0321625 A1
(43) Pub. Date: Dec. 5, 2013

(54) ELECTRONIC DEVICE AND INFORMATION TRANSMISSION SYSTEM

(71) Applicants: Masamitsu Yanagihara, Zama-shi (JP); Tetsuya Yamamoto, Hasuda-shi (JP); Masahiro Nei, Yokohama-shi (JP); Satoshi Hagiwara, Yokohama-shi (JP); Isao Totsuka, Nishitokyo-shi (JP); Masakazu Sekiguchi, Kawasaki-shi (JP); Tomoyuki Matsuyama, Kuki-shi (JP)

(72) Inventors: Masamitsu Yanagihara, Zama-shi (JP); Tetsuya Yamamoto, Hasuda-shi (JP); Masahiro Nei, Yokohama-shi (JP); Satoshi Hagiwara, Yokohama-shi (JP); Isao Totsuka, Nishitokyo-shi (JP); Masakazu Sekiguchi, Kawasaki-shi (JP); Tomoyuki Matsuyama, Kuki-shi (JP)

(73) Assignee: NIKON CORPORATION, Tokyo (JP)

(21) Appl. No.: 13/985,751

(22) PCT Filed: Mar. 21, 2012
(86) PCT No.: PCT/JP2012/057215

§ 371 Date: Aug. 15, 2013

(30) Foreign Application Priority Data
Mar. 28, 2011 (JP) 2011-070327
Mar. 28, 2011 (JP) 2011-070358

(51) Int. Cl. H04R 1/32

(52) U.S. Cl. CPC H04R 1/32
USPC 348/143

(57) ABSTRACT

Provided is an electronic device capable of controlling an appropriate voice device, the electronic device including: an acquisition device that acquires an image capturing result from at least one image capturing device capable of capturing an image containing a subject person; a control device configured to control a voice device located outside an image capturing region of the image capturing device in accordance with the image capturing result of the image capturing device.

### TECHNICAL FIELD

The present invention relates to electronic devices and information transmission systems.

### BACKGROUND ART

There has been suggested a voice guidance device that guides a user by voice (see Patent Document 1 for example).

### PRIOR ART DOCUMENTS

### Patent Documents

Patent Document 1: Japanese Patent Application Publication No. 2007-45565

### SUMMARY OF THE INVENTION

### Problems to be Solved by the Invention

However, the conventional voice guidance device has a problem that a person who is not at a certain position has a difficulty in hearing the voice.

The present invention has been made in view of the above problem, and thus aims to provide an electronic device and an information transmission system capable of controlling an appropriate voice device.

### Means for Solving the Problems

An electronic device of the present invention is an electronic device including: an acquisition device that acquires an image capturing result from at least one image capturing device capable of capturing an image containing a subject person; a control device configured to control a voice device located outside an image capturing region of the image capturing device in accordance with the image capturing result of the image capturing device.

In this case, a detecting device configured to detect move information of the subject person based on the image capturing result of the at least one image capturing device may be included, and the control device may control the voice device based on a detection result of the detecting device. In addition, in this case, the control device may control the voice device to warn the subject person when determining that the subject person moves outside a predetermined area or has moved outside a predetermined area based on the move information detected by the detecting device.

In the electronic device of the present invention, the control device may control the voice device when the at least one image capturing device captures an image of a person other than the subject person. In addition, the voice device may include a directional loudspeaker. In addition, a drive control device configured to adjust a position and/or attitude of the voice device may be included. In this case, the drive control device may adjust the position and/or attitude of the voice device in accordance with a move of the subject person.

In the electronic device of the present invention, the at least one image capturing device may include a first image capturing device and a second image capturing device, the first and second image capturing devices may be arranged so that a part of an image capturing region of the first image capturing device overlaps a part of an image capturing region of the second image capturing device.

In addition, the voice device may include a first voice device located in the image capturing region of the first image capturing device and a second voice device located in the image capturing region of the second image capturing device, and the control device may control the second voice device when the first voice device is positioned at a back side of the subject person. In this case, the voice device may include a first voice device including a first loudspeaker located in the image capturing region of the first image capturing device and a second voice device including a second loudspeaker located in the image capturing region of the second image capturing device, and the control device controls the second loudspeaker when the first image capturing device may capture an image of the subject person and an image of a person other than the subject person. In addition, the first voice device may include a microphone, and the control device may control the microphone to collect voice of the subject person when the first image capturing device captures an image of the subject person.

In the electronic device of the present invention, a tracking device configured to track the subject person using the image capturing result of the image capturing device may be included, and the tracking device may acquire an image of a specific portion of the subject person using the image capturing device, set the image of the specific portion as a template, identify the specific position of the subject person using the template when tracking the subject person, and update the template with a new image of the specific portion of the identified subject person.

In this case, the image capturing device may include a first image capturing device and a second image capturing device having an image capturing region overlapping a part of an image capturing region of the first image capturing device, and the tracking device may acquire positional information of the specific portion of the subject person whose image is captured by one of the image capturing devices when the first image capturing device and the second image capturing device simultaneously capture images of the subject person, and identify a region corresponding to the positional information of the specific portion in an image captured by the other of the image capturing devices, and set an image of the identified region as the template for the other of the image capturing devices. In addition, the tracking device may determine that a trouble has happened to the subject person when size information of the specific portion changes more than a given amount.

An information transmission system of the present invention is an information transmission system including: at least one image capturing device capable of capturing an image containing a subject person; a voice device located outside an image capturing region of the image capturing device; and the electronic device of the present invention.

An electronic device of the present invention is an electronic device including: an acquisition device configured to acquire an image capturing result of an image capturing device capable of capturing an image containing a subject person; a first detecting device configured to detect size information of the subject person from the image capturing result of the image capturing device; and a drive control device configured to adjust a position and/or attitude of a voice device with directionality based on the size information detected by the first detecting device.

In this case, a second detecting device configured to detect positions of ears of the subject person based on the size information detected by the first detecting device may be included. In this case, the drive control device may adjust the position and/or attitude of the voice device with directionality based on the positions of the ears detected by the second detecting device.

In the electronic device of the present invention, a setting device configured to set an output of the voice device with directionality based on the size information detected by the first detecting device may be included. In addition, a control device configured to control a voice guidance by the voice device with directionality in accordance with a position of the subject person may be included.

In addition, in the electronic device of the present invention, the drive control device may adjust the position and/or attitude of the voice device with directionality in accordance with a move of the subject person. Moreover, the voice device with directionality may be located near the image capturing device. In addition, a correcting device configured to correct the size information of the subject person detected by the first detecting device based on a positional relationship between the subject person and the image capturing device may be included.

In addition, in the electronic device of the present invention, a tracking device configured to track the subject person using the image capturing result of the image capturing device may be included, and the tracking device may acquire an image of a specific portion of the subject person using the image capturing device and set the image of the specific portion as a template, and identify the specific position of the subject person using the template when tracking the subject person and update the template with a new image of the specific portion of the identified subject person.

In this case, the image capturing device may include a first image capturing device and a second image capturing device having an image capturing region overlapping a part of an image capturing region of the first image capturing device, and the tracking device may acquire positional information of the specific portion of the subject person whose image is captured by one of the image capturing devices when the first image capturing device and the second image capturing device simultaneously capture images of the subject person, and identify a region corresponding to the positional information of the specific portion in an image captured by the other of the image capturing devices and set an image of the identified region as the template for the other of the image capturing devices. In addition, the tracking device may determine that a trouble has happened to the subject person when the size information of the specific portion changes more than a given amount.

An electronic device of the present invention includes an ear detecting device configured to detect positions of ears of a subject person; and a drive control device configured to adjust a position and/or attitude of a voice device with directionality based on a detection result of the ear detecting device.

In this case, the ear detecting device may include an image capturing device capturing an image of the subject person, and detects the positions of the ears of the subject person from information relating to a height of the subject person based on the captured image by the image capturing device. In addition, the ear detecting device may detect the positions of the ears from a moving direction of the subject person.

An electronic device of the present invention includes a position detecting device configured to detect a position of a subject person; and a selecting device configured to select at least one directional loudspeaker from directional loudspeakers based on a detection result of the position detecting device.

In this case, a drive control device configured to adjust a position and attitude of the directional loudspeaker selected by the selecting device may be included. In addition, the drive control device may adjust the position and/or attitude of the directional loudspeaker toward the ears of the subject person.

An information transmission system of the present invention is an information transmission system including: at least one image capturing device capable of capturing an image containing a subject person; a voice device with directionality; and the electronic device of the present invention.

### Effects of the Invention

Electronic devices and information transmission systems of the present invention can control an appropriate voice device.

### BRIEF DESCRIPTION OF DRAWINGS

FIG. 1 is a block diagram illustrating a configuration of a guidance system in accordance with an embodiment;

FIG. 2 is a diagram illustrating a tangible configuration of an image capturing device;

FIG. 3 is a perspective view illustrating a voice unit;

FIG. 4 is a hardware configuration diagram of a main unit;

FIG. 5 is a functional block diagram of the main unit;

FIG. 6A is a graph illustrating a relationship between a distance from a front side focal point of a wide-angle lens system to the head of a person whose image is captured (subject person) and the size of an image (head portion), and FIG. 6B is a graph formed by converting the graph of FIG. 6A into a height from a floor;

FIG. 7 is a graph illustrating a rate of change in the size of an image;

FIG. 8A and FIG. 8B are diagrams schematically illustrating changes of the size of the head of the subject person in accordance with his/her posture;

FIG. 9 is a diagram illustrating changes of the size of the head of the subject person whose image is captured by an imaging element in accordance with a position of the subject person;

FIG. 10 is a diagram schematically illustrating a relationship between one section in an office and image capturing regions of image capturing devices located in the section;

FIG. 11 is a diagram for explaining a process of tracking a subject person (No. 1);

FIG. 12 is a diagram for explaining the process of tracking the subject person (No. 2);

FIG. 13 is a diagram for explaining the process of tracking the subject person (No. 3);

FIG. 14A and FIG. 14B are diagrams for explaining the tracking process when four subject persons (subject persons A, B, C, D) move around in one section in FIG. 10 (No. 1);

FIG. 15A through FIG. 15C are diagrams for explaining the tracking process when four subject persons (subject persons A, B, C, D) move around in the section in FIG. 10 (No. 2);

FIG. 16 is a diagram for explaining a method of controlling a directional loudspeaker when guidance units are arranged along a passageway (hallway); and

FIG. 17 is a flowchart illustrating a guidance process of the guidance system.

### MODES FOR CARRYING OUT THE INVENTION

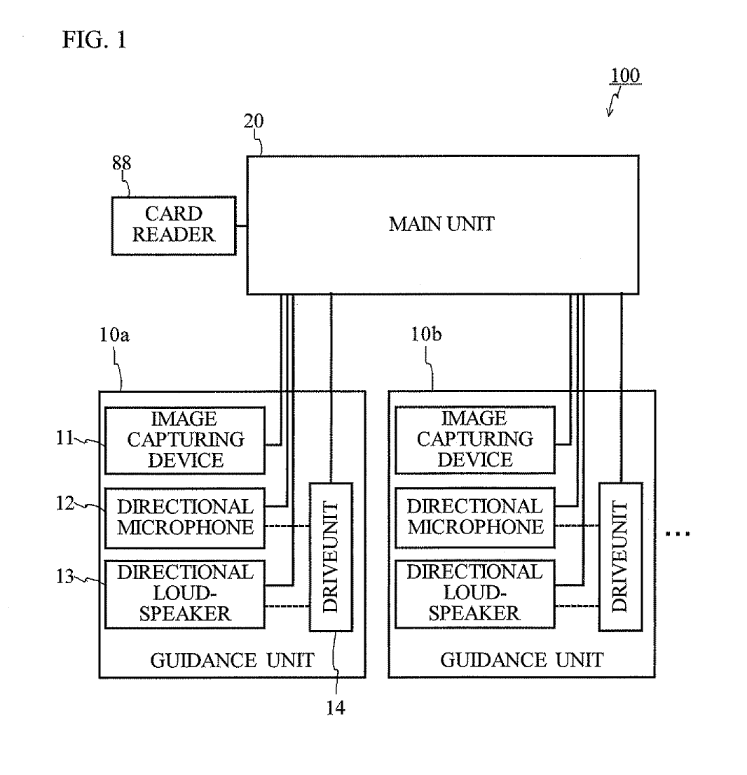

Hereinafter, a description will be given of a guidance system in accordance with an embodiment with reference to FIG. 1 through FIG. 17. FIG. 1 is a block diagram illustrating a configuration of a guidance system 100. The guidance system 100 may be installed in offices, commercial facilities, airports, stations, hospitals, and museums, but the present embodiment describes a case where the guidance system 100 is installed in an office.

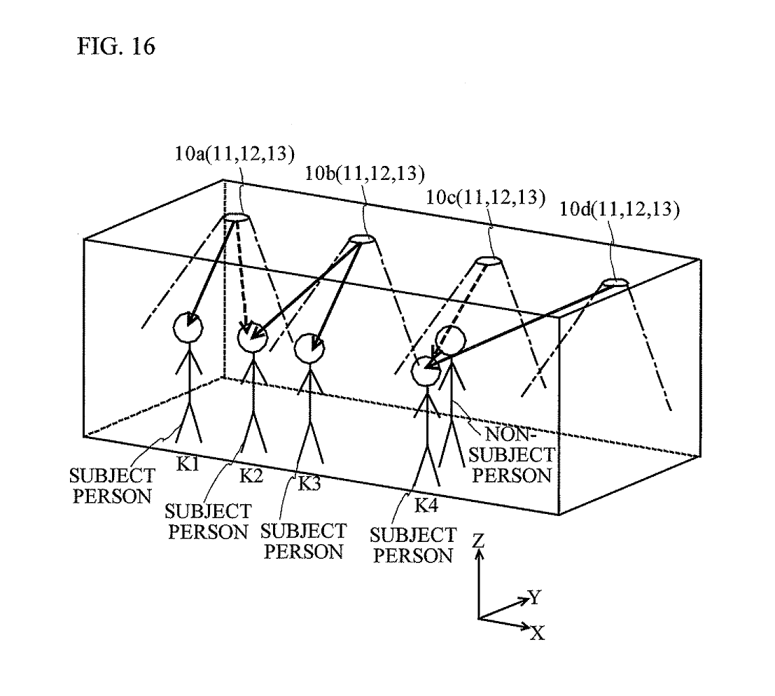

As illustrated in FIG. 1, the guidance system 100 includes guidance units 10a, 10b, . . . , a card reader 88, and a main unit 20. FIG. 1 illustrates only two guidance units 10a, 10b, but the number thereof can be selected in accordance with an installed location. For example, FIG. 16 illustrates a state where four guidance units 10a through 10d are located in a passageway. Assume that the guidance units 10a, 10b, has the same configuration. In addition, an arbitrary guidance unit of the guidance units 10a, 10b, . . . is described as a guidance unit 10 hereinafter.

The guidance unit 10 includes an image capturing device 11, a directional microphone 12, a directional loudspeaker 13, and a drive device 14.

The image capturing device 11 is located on the ceiling of an office, and mainly captures an image of the head of a person in the office. In the present embodiment, the height of the ceiling of the office is 2.6 m. That is to say, the image capturing device 11 captures an image of the head of a person from a height of 2.6 m.

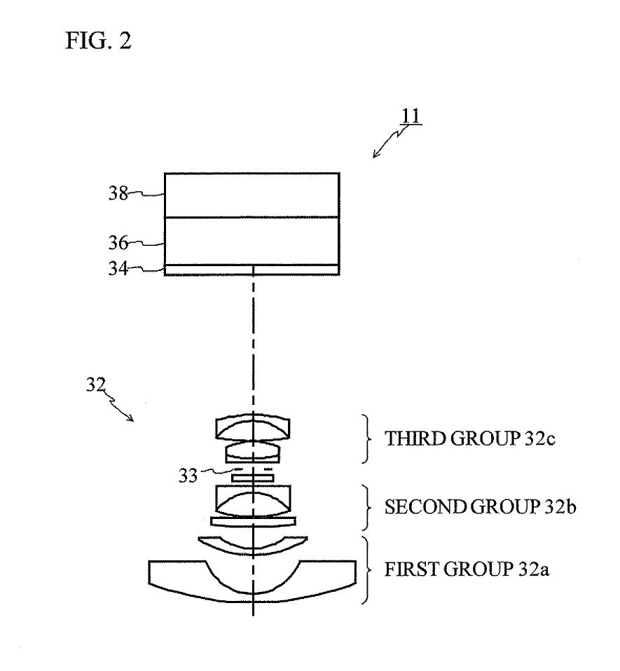

As illustrated in FIG. 2, the image capturing device 11 includes a wide-angle lens system 32 with a three group structure, a low-pass filter 34, an imaging element 36 including a CCD or a CMOS, and a circuit board 38 that drives and controls the imaging element. Not illustrated in FIG. 2, but a mechanical shutter, which is not illustrated, is located between the wide-angle lens system 32 and the low-pass filter 34.

The wide-angle lens system 32 includes a first group 32a having two negative meniscus lenses, a second group 32b having a positive lens, a cemented lens, and an infrared filter, and a third group 32c having two cemented lenses, and a diaphragm 33 is located between the second group 32b and the third group 32c. The wide-angle lens system 32 of the present embodiment has a focal length of 6.188 mm and a maximum angle of view of 80° throughout the system. The wide-angle lens system 32 is not limited to have a three-group structure. In other words, the number of lenses and the lens constitution in each group, and the focal length and the angle of view may be arbitrarily changed.

The imaging element 36 is 23.7 mm×15.9 mm in size for example, and has 4000×3000 pixels (12 million pixels), for example. That is to say, the size of each one pixel is 5.3 μm. However, the imaging element 36 may be an image sensor having a different size and a different number of pixels from those described above.

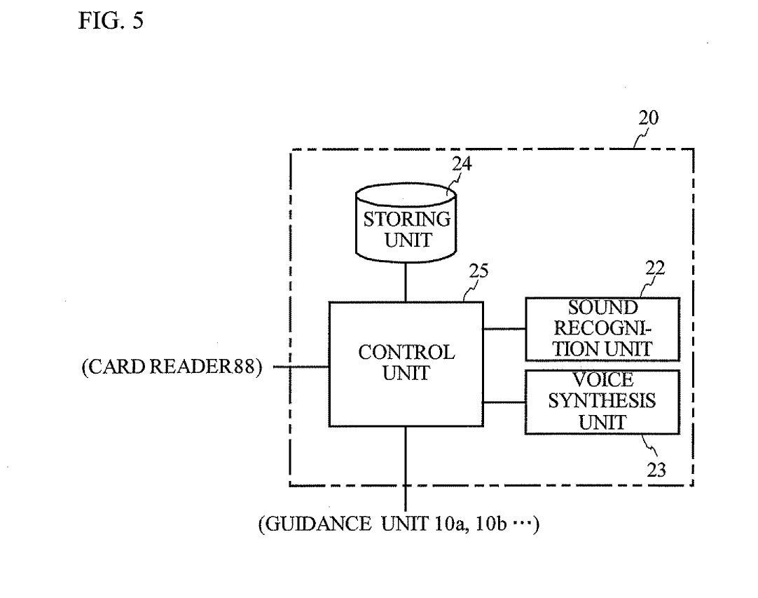

In the image capturing device 11 configured as described above, the luminous flux incident on the wide-angle lens system 32 enters the imaging element 36 via the low-pass filter 34, and the circuit board 38 converts the output from the imaging element 36 into a digital signal. Then, an image processing control unit (not illustrated) including an ASIC (Application Specific Integrated Circuit) executes an image processing such as white balance adjustment, sharpness adjustment, gamma correction, and tone adjustment to the image signal converted into the digital signal, and executes an image compression using JPEG or the like. The image processing control unit also transmits still images compressed using JPEG to a control unit 25 (see FIG. 5).

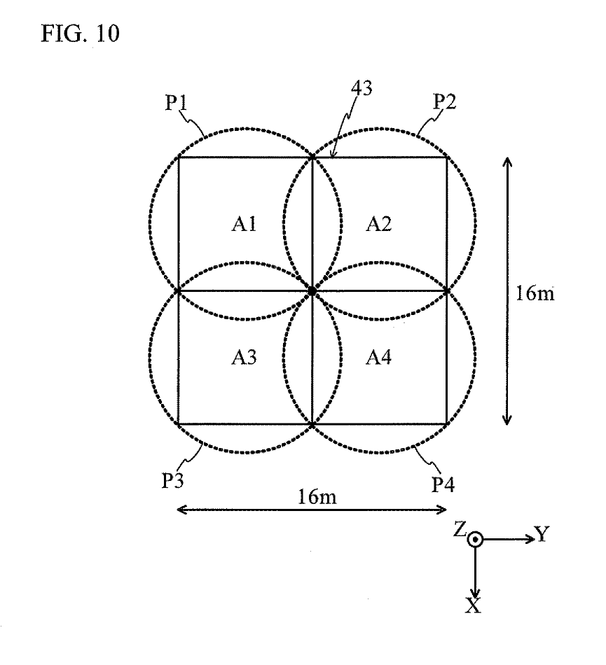

The image capturing region of the image capturing device 11 overlaps the image capturing region of the image capturing device 11 included in the adjoining guidance unit 10 (see image capturing regions P1 through P4 in FIG. 10). This will be described later.

The directional microphone 12 collects sound incoming from a certain direction (e.g. an anterior direction), and a superdirective dynamic microphone or a superdirective capacitive microphone may be used therefor.

The directional loudspeaker 13 includes an ultrasonic transducer, and is a speaker transmitting sound toward only a limited direction.

The drive device 14 integrally or separately drives the directional microphone 12 and the directional loudspeaker 13.

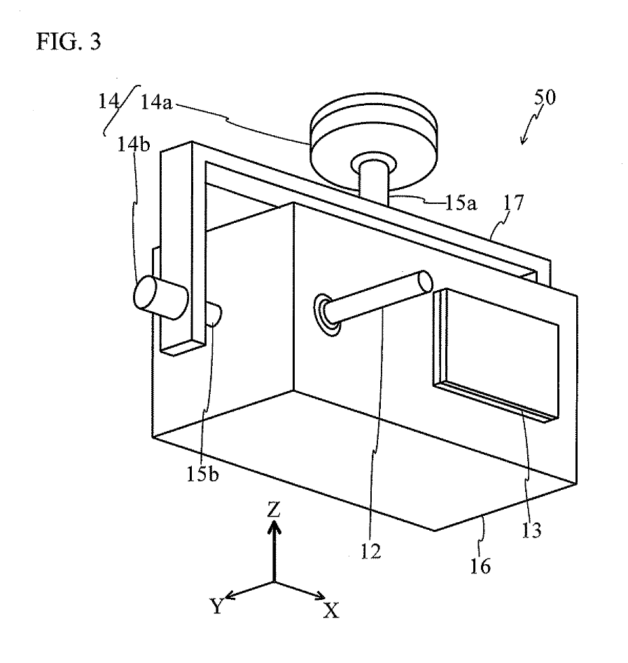

As illustrated in FIG. 3, the present embodiment locates the directional microphone 12, the directional loudspeaker 13, and the drive device 14 in an all-in-one voice unit 50. More specifically, the voice unit 50 includes a unit body 16 holding the directional microphone 12 and the directional loudspeaker 13, and a holding unit 17 holding the unit body. The holding unit 17 rotatably holds the unit body 16 with a rotating shaft 15b extending in a horizontal direction (X-axis direction in FIG. 3). The holding unit 17 includes a motor 14b constituting the drive device 14, and the unit body 16 (i.e. the directional microphone 12 and the directional loudspeaker 13) are driven in a pan direction (moved in the horizontal direction) by the rotative force of the motor 14b. In addition, the holding unit 17 includes a rotating shaft 15a extending in a vertical direction (Z-axis direction), and the rotating shaft 15a is rotated by the motor 14a (fixed to the ceiling portion of the office) constituting the drive device 14. This allows the unit body 16 (i.e. the directional microphone 12 and the directional loudspeaker 13) to be driven in a tilt direction (moved in the vertical direction (Z-axis direction)). A DC motor, a voice coil motor, or a linear motor may be used for the motors 14a, 14b.

The motor 14a drives the directional microphone 12 and the directional loudspeaker 13 within a range of approximately 60° to 80° in a clockwise direction and an anticlockwise direction from a state where the directional microphone 12 and the directional loudspeaker 13 turn to the floor (−90°. The reason why the drive range is set to the above described range is because the head of a person may be located directly beneath the voice unit 50 but is unlikely to be located right beside the voice unit 50 when the voice unit 50 is located on the ceiling portion of the office.

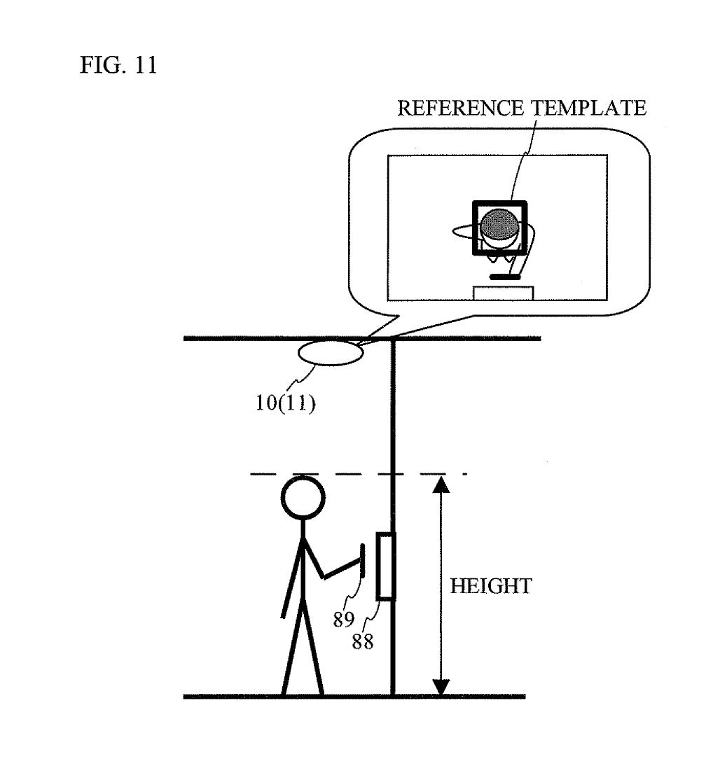

The present embodiment separates the voice unit 50 from the image capturing device 11 in FIG. 11, but does not intend to suggest any limitation, and may unitize the whole of the guidance unit 10 and locate it on the ceiling portion.

Back to FIG. 1, the card reader 88 is located at an office entrance, and reads out an ID card held by a person who is permitted to enter the office.

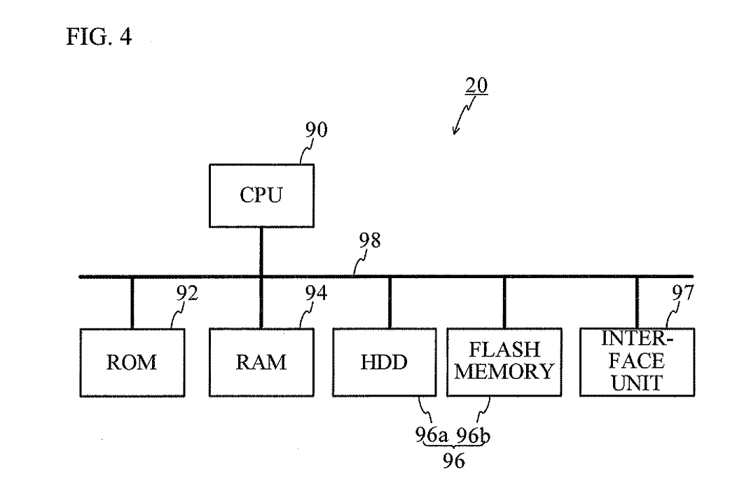

The main unit 20 processes information (data) input from the guidance units 10a, 10b, . . . and the card reader 88, and overall controls the guidance units 10a, 10b, . . . and the card reader 88. FIG. 4 illustrates a hardware configuration of the main unit 20. As illustrated in FIG. 4, the main unit 20 includes a CPU 90, a ROM 92, a RAM 94, a storing unit (here, an HDD (Hard Disk Drive) 96a and a flash memory 96b), and an interface unit 97. The components of the main unit 20 are coupled to a bus 98. The interface unit 97 is an interface to connect to the image capturing device 11 and the drive device 14 of the guidance unit 10. Various connection standards such as wireless/wired LAN, USB, HDMI, and Bluetooth (registered trademark) may be used for the interface.

The main unit 20 achieves the function of each unit in FIG. 5 by executing a program stored in the ROM 92 or the HDD 96a by the CPU 90. That is to say, the main unit 20 functions as a sound recognition unit 22, a voice synthesis unit 23, and the control unit 25 illustrated in FIG. 5 by executing the program by the CPU 90. FIG. 5 also illustrates a storing unit 24 achieved by the flash memory 96b in FIG. 4.

The sound recognition unit 22 recognizes sound based on a feature quantity of the sound collected by the directional microphone 12. The sound recognition unit 22 has an acoustic model and a dictionary function, and performs sound recognition using the acoustic model and the dictionary function. The acoustic model stores acoustic features such as phoneme and syllable of a speech language to be sound-recognized. The dictionary function stores phonological information relating to the pronunciation of each word to be recognized. The sound recognition unit 22 may be achieved by executing a commercially available sound recognition software (program) by the CPU 90. Japanese Patent No. 4587015 (Japanese Patent Application Publication No. 2004-325560) describes the sound recognition technology.

The voice synthesis unit 23 synthesizes voice emitted (output) from the directional loudspeaker 13. The voice can be synthesized by generating phonological synthesis units and then connecting the synthesis units. The principle of the voice synthesis is storing feature parameters of basic small units such CV, CVC, VCV, where C (Consonant) represents consonants and V (Vowel) represents vowels, and synthesis units and connecting them while controlling a pitch and continuance to synthesize voice. Japanese Patent No. 3727885 (Japanese Patent Application Publication No. 2003-223180) discloses the voice synthesis technology, for example.

The control unit 25 controls the whole of the guidance system 100 in addition to the main unit 20. For example, the control unit 25 stores still images compressed using JPEG transmitted from the image processing control unit of the image capturing device 11 in the storing unit 24. In addition, the control unit 25 determines, based on an image stored in the storing unit 24, which directional loudspeaker 13 of the directional loudspeakers 13 is used to guide a specific person (subject person) in the office.

In addition, the control unit 25 controls the drive of the directional microphone 12 and the directional loudspeaker 13 in accordance with the distance to the adjoining guidance unit 10 so that the sound collecting range and the voice output range of them overlap at least those of the adjoining guidance unit 10. Moreover, the control unit 25 drives the directional microphone 12 and the directional loudspeaker 13 so that the voice guidance can be performed in the region wider than the image capturing region of the image capturing device 11, and sets the sensitivity of the directional microphone 12 and the volume of the directional loudspeaker 13. This is because there is a case where the directional microphone 12 and the directional loudspeaker 13 of the guidance unit 10 with the image capturing device that is not capturing an image of the subject person is used to guide the subject person by voice.

In addition, the control unit 25 acquires card information of an ID card read out by the card reader 88, and identifies a person who passed the ID card over the card reader 88 based on employee information or the like stored in the storing unit 24.

The storing unit 24 stores a correction table (described later) for correcting a detection error due to the distortion of the optical system in the image capturing device 11, employee information, and images captured by the image capturing devices 11.

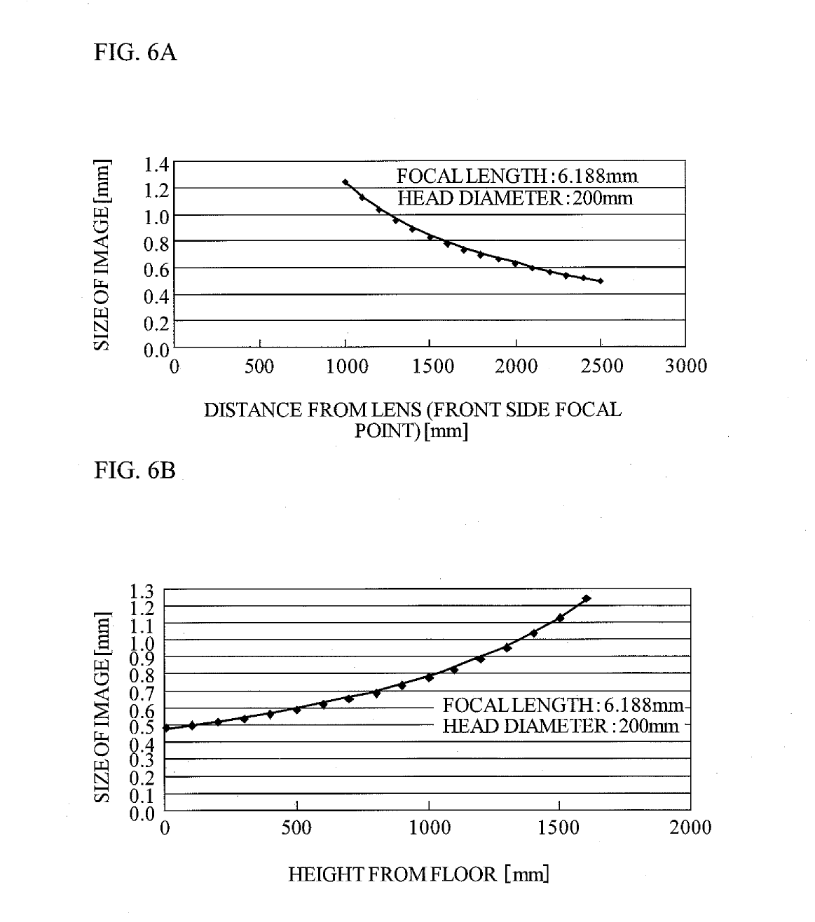

A detailed description will next be given of image capturing of the head portion of a subject person by the image capturing device 11. FIG. 6A is a graph illustrating a relationship between a distance from a front side focal point of the wide-angle lens system 32 to the head of a person (subject person) whose image is captured and the size of an image (head portion), and FIG. 6B illustrates a graph in which a distance in FIG. 6A is converted into a height from a floor.

Here, when the focal length of the wide-angle lens system 32 is 6.188 mm as described previously, and the diameter of the head of the subject person is 200 mm, the diameter of the head of the subject person focused on the imaging element 36 of the image capturing device 11 is 1.238 mm in a case where the distance from the front side focal point of the wide-angle lens system 32 to the position of the head of the subject person is 1000 mm (in other words, when a 160-centimeter-tall person is standing). On the other hand, when the position of the head of the subject person lowers by 300 mm, and the distance from the front side focal point of the wide-angle lens system 32 to the position of the head of the subject person becomes 1300 min, the diameter of the head of the subject person focused on the imaging element of the image capturing device 11 becomes 0.952 mm. In other words, in this case, the change in the height of the head by 300 mm changes the size of the image (diameter) by 0.286 mm (23.1%).

In the same manner, when the distance from the front side focal point of the wide-angle lens system 32 to the position of the head of the subject person is 2000 mm (when the subject person is semi-crouching), the diameter of the head of the subject person focused on the imaging element 36 of the image capturing device 11 is 0.619 mm, and when the position of the head of the subject person lowers therefrom by 300 mm, the size of the image of the head of the subject person focused on the imaging element of the image capturing device 11 becomes 0.538 mm. That is to say, in this case, the change in the height of the head by 300 mm changes the size of the image of the head (diameter) by 0.081 mm (13.1%). As described above, in the present embodiment, the change in the size of the image of the head (rate of change) decreases as the distance from the front side focal point of the wide-angle lens system 32 to the head of the subject person increases.

Generally, a difference in height between two persons is approximately 300 mm when they are adult, and a difference in head size is one digit smaller than that in height, but the difference in height and the difference in head size tend to satisfy a given relationship. Thus, the height of a subject person can be estimated by comparing a standard size of a head (e.g. a diameter of 200 mm) and the size of the head of the subject person whose image is captured. In addition, ears are generally positioned 150 mm to 200 mm below the top of a head, and thus the height positions of the ears of the subject person can be also estimated from the size of the head. A person entering an office often stands, and thus the distance from the front side focal point of the wide angle lens system to the subject person can be determined from the size of the head of the subject person once the height of the subject person and the height positions of the ears are estimated by capturing an image of the head by the image capturing device 11 located near the reception, and therefore a posture of the subject person (standing, semi-crouching, lying on the floor) and the change of the posture can be determined while the privacy of the subject person is protected. When the subject person is lying on the floor, the ear is estimated to be positioned at approximately 150 to 200 mm from the top of the head toward the toe. As described above, the use of the position and the size of the head of which image is captured by the image capturing device 11 enables to estimate the positions of the ears even though the hair covers over the ears for example. In addition, when the subject person is moving, the positions of the ears can be estimated with the moving direction and the position of the top of the head.

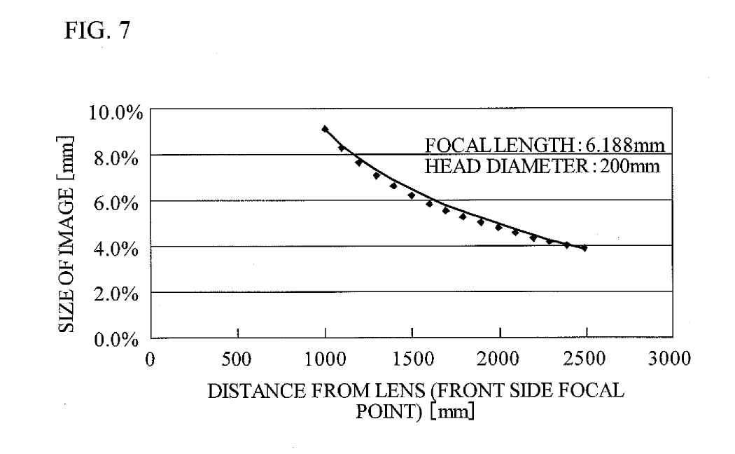

FIG. 7 is a graph illustrating a rate of change in the size of the image of a head. FIG. 7 illustrates the rate of change in the size of the image when the position of the head of the subject person changes by 100 mm from the value indicated in the horizontal axis. FIG. 7 reveals that two or more subject persons can be easily identified based on a difference in height if the difference in height is approximately 100 mm even though the sizes of their heads are identical because the rate of change in the size of the image is 9.1% and large when the distance from the front side focal point of the wide-angle lens system 32 to the position of the head of the subject person lowers by 100 mm from 1000 mm. In contrast, when the distance from the front side focal point of the wide-angle lens system 32 to the position of the head of the subject person lowers by 100 mm from 2000 mm, the rate of change in the size of the image is 4.8%. In this case, although the rate of change of the image is small compared to the above-described case where the distance from the front side focal point of the wide-angle lens system 32 to the position of the head of the subject person lowers by 100 mm from 1000 mm, the change of the posture of the same subject person can be easily identified.

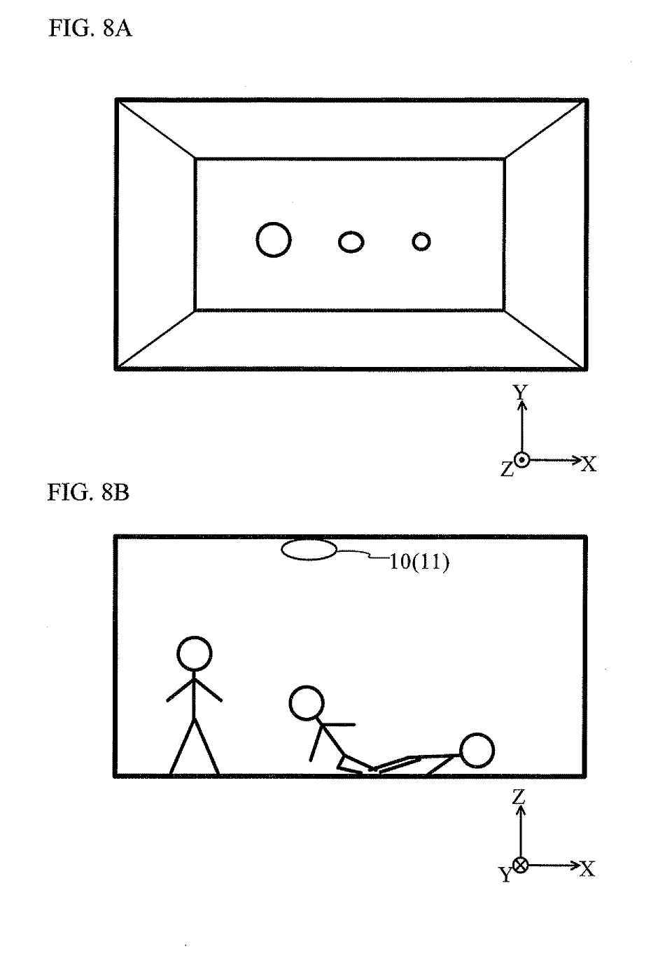

As described above, the use of the image capturing result of the image capturing device 11 of the present embodiment allows the distance from the front side focal point of the wide-angle lens system 32 to the subject person to be detected from the size of the image of the head of the subject person, and thus, the posture of the subject person (standing, semi-crouching, lying on the floor) and the change of the posture can be determined by using the detection results. A detailed description will be given of this point with reference to FIG. 8A and FIG. 8B.

FIG. 8A and FIG. 8B are diagrams schematically illustrating a change of the size of the image of the head in accordance with postures of the subject person. When the image capturing device 11 located on the ceiling captures an image of the head of the subject person as illustrated in FIG. 8B, the captured image of the head is large as illustrated in FIG. 8A in a case where the subject person is standing as illustrated at the left side of FIG. 8B, and the captured image of the head is small as illustrated in FIG. 8A in a case where the subject person is lying on the floor as illustrated at the right side of FIG. 8B. In addition, when the subject person is semi-crouching as illustrated at the center of FIG. 8B, the image of the head is larger than that in a case of standing and smaller than that in a case of lying on the floor. Therefore, in the present embodiment, the control unit 25 can determine the state of the subject person by detecting the size of the image of the head of the subject person based on the images transmitted from the image capturing devices 11. In this case, the posture of the subject person and the change of the posture are determined based on the image of the head of the subject person, and thus the privacy is protected compared to the determination using the face or the whole body of the subject person.

FIG. 6A, FIG. 6B, and FIG. 7 illustrate graphs when the subject person is present in a position at which the angle of view of the wide-angle lens system 32 is low (immediately below the wide-angle lens system 32). That is to say, when the subject person is present in a position at the peripheral angle of view of the wide-angle lens system 32, there may be the influence of a distortion depending on an anticipated angle with respect to the subject person. This will now be described in detail.

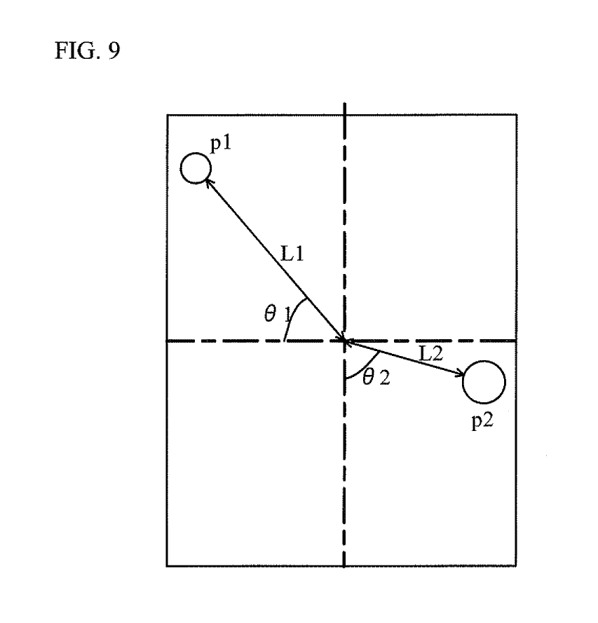

FIG. 9 illustrates a change of the size of the image of the head of the subject person imaged by the imaging element 36 in accordance with positions of the subject person. Assume that the center of the imaging element 36 corresponds to the center of the optical axis of the wide-angle lens system 32. In this case, even when the subject person is standing, the size of the image of the head captured by the image capturing device 11 varies because of the influence of a distortion between a case where he/she is standing immediately below the image capturing device 11 and a case where he/she is standing away from the image capturing device 11. Here, when the image of the head is captured at position p1 of FIG. 9, the image capturing result enables to obtain the size of the image imaged by the imaging element 36, a distance L1 from the center of the imaging element 36, and an angle θ1 from the center of the imaging element 36. In addition, when the image of the head is captured at position p2 of FIG. 9, the image capturing result enables to obtain the size of the image imaged by the imaging element 36, a distance L2 from the center of the imaging element 36, and an angle θ2 from the center of the imaging element 36. The distances L1, L2 are parameters representing the distance between the front side focal point of the wide-angle lens system 32 and the head of the subject person. The angles θ1, θ2 from the center of the imaging element 36 are parameters representing an anticipated angle of the wide-angle lens system 32 with respect to the subject person. In such a case, the control unit 25 corrects the size of the captured image based on the distances L1, L2 from the center of the imaging element 36 and the angles θ1, θ2 from the center of the imaging element 36. In other words, the size of the captured image at position p1 of the imaging element 36 is corrected so as to be practically equal to the size of the captured image at position p2 when the subject person is in the same posture. The above correction allows the present embodiment to accurately detect the posture of the subject person regardless of the positional relationship between the image capturing device 11 and the subject person (the distance to the subject person and the anticipated angle with respect to the subject person). The parameters used for the correction (correction table) are stored in the storing unit 24.

Here, the control unit 25 sets time intervals at which images are captured by the image capturing device 11. The control unit 25 can change image capture frequency (frame rate) between a time period in which many people are likely to be in the office and a time period other than that. For example, the control unit 25 may set the time intervals so that one still image is captured per minute (32400 images per day) when determining that the current time is in a time period in which many people are likely to be in the office (for example, from 9:00 am to 6:00 pm), and may set the time intervals so that one still image is captured at 5-second intervals (6480 images per day) when determining the current time is in the other time period. In addition, the captured still images may be temporarily stored in the storing unit 24 (flash memory 96b), and then deleted from the storing unit 24 after data of captured images for one day is stored in the HDD 96a for example.

Video images may be captured instead of still images, and in this case, the video images can be continuously captured, or short video images each lasting 3 to 5 seconds may be captured intermittently.

A description will next be given of the image capturing region of the image capturing device 11.

FIG. 10 is a diagram schematically illustrating a relationship between one section 43 in the office and the image capturing regions of the image capturing devices 11 located in the section 43. In FIG. 10, four image capturing devices 11 are located in one section 43 (only four image capturing regions P1, P2, P3, and P4 are illustrated). One section is 256 m² (16 m×16 m). Further, the image capturing regions P1 through P4 are circle regions, and overlap the adjoining image capturing regions in the X direction and the Y direction. FIG. 10 illustrates divided areas formed by dividing one section into four (corresponding to the image capturing regions P1 through P4) as divided areas A1 through A4 for convenience sake. In this case, when the wide-angle lens system 32 has an angle of view of 80°, a focal length of 6.188 mm, the height of the ceiling is 2.6 m, and the height of the subject person is 1.6 m, a region within a circle having a center immediately below the wide-angle lens system 32 and a radius of 5.67 m (approximately 100 m²) becomes the image capturing region. That is to say, each of the divided areas A1 through A4 has an area of 64 m², and thus the divided areas A1 through A4 can be included in the image capturing regions P1 through P4 of the image capturing devices 11 respectively, and parts of the image capturing regions of the image capturing devices 11 can overlap each other.

FIG. 10 illustrates the concept of the overlap among the image capturing regions P1 through P4 from the object side, but the image capturing regions P1 through P4 represent the regions in which light enters the wide-angle lens system 32, and all the light incident on the wide-angle lens system 32 do not enter the rectangular imaging element 36 Thus, in the present embodiment, the image capturing devices 11 have only to be located in the office so that the image capturing regions P1 through P4 of the adjoining imaging elements 36 overlap each other. More specifically, the image capturing device 11 may include an adjustment portion (e.g. an elongate hole, a large adjustment hole, or a shift optical system adjusting an image capturing position) for adjusting the installation thereof, and the installation positions of the image capturing devices 11 may be determined by adjusting the overlap while visually confirming the images captured by the imaging elements 36. When the divided area A1 illustrated in FIG. 10 coincides with the image capturing region of the imaging element 36 for example, the images captured by the image capturing devices 11 do not overlap but coincide with each other. However, the image capturing regions P1 through P4 of the imaging elements 36 preferably overlap each other as described previously in terms of the degree of freedom in installing the image capturing devices 11 and the difference in installation height due to a beam in the ceiling.

The overlapping amount can be determined based on a size of a human head. In this case, when the outer periphery of a head is 60 cm, it is sufficient if a circle with a diameter of approximately 20 cm is included in the overlapping region. When only a part of a head should be included in the overlapping region, it is sufficient if a circle with a diameter of approximately 10 cm is included. The overlapping amount set as described eases the adjustment in installing the image capturing device 11 on the ceiling, and the image capturing regions of the image capturing devices 11 can overlap each other without adjustment in some situations.

A description will next be given of a tracking process of a subject person using the guidance unit 10 (image capturing device 11) with reference to FIG. 11 through FIG. 13. FIG. 11 schematically illustrates a subject person entering the office.

A description will first be given of a process executed when the subject person enters the office with reference to FIG. 11. As illustrated in FIG. 11, when the subject person enters the office, the subject person passes his/her ID card 89 over the card reader 88. The card information acquired by the card reader 88 is transmitted to the control unit 25. The control unit 25 identifies the subject person who passed the ID card 89 based on the acquired card information and employee information stored in the storing unit 24. When the subject person is not an employee, he/she passes a guest card handed at a general reception or a guard gate, and thus the subject person is identifies as a guest person.

The control unit 25 starts capturing an image of the head of the subject person with the image capturing device 11 of the guidance unit 10 located above the card reader 88 from the time when the subject person is identified as described above. Then, the control unit 25 cuts out an image portion that is supposed to be a head from an image captured by the image capturing device 11 as a reference template, and registers it in the storing unit 24.

The image portion that is supposed to be the head may be extracted from the image captured by the image capturing device 11 by

(1) preliminarily registering templates of images of the heads of subject persons and performing pattern matching with these images to extract a head portion; or
(2) extracting a circular portion with a supposed size as a head portion.

Before the above-described head portion is extracted, an image of the subject person may be captured from the front side with a camera located near the card reader, and it may be predicted in which part of the image capturing region of the image capturing device 11 the image of the head is captured. In this case, the position of the head of the subject person may be estimated based on the face recognition result of the image of the camera, or the position of the head of the subject person may be predicted by using a stereo camera as a camera, for example. The above described process enables to extract a head portion with a high degree of accuracy.

Here, the height of the subject person is preliminarily registered in the storing unit 24, and the control unit 25 associates the height with the reference template. When the subject person is a guest person, his/her height is measured by the previously-described camera capturing the image of the subject person from the front side, and the measured height is associated with the reference template.

In addition, the control unit 25 generates templates (composite templates) formed by scaling the reference template, and stores them in the storing unit 24. In this case, the control unit 25 generates templates for the sizes of the head, of which image is to be captured by the image capturing device 11 when the height of the head changes by the 10 cm, as the composite templates. When generating the composite template, the control unit 25 considers the relationship between the optical characteristics of the image capturing device 11 and the capturing position when the reference template was acquired.

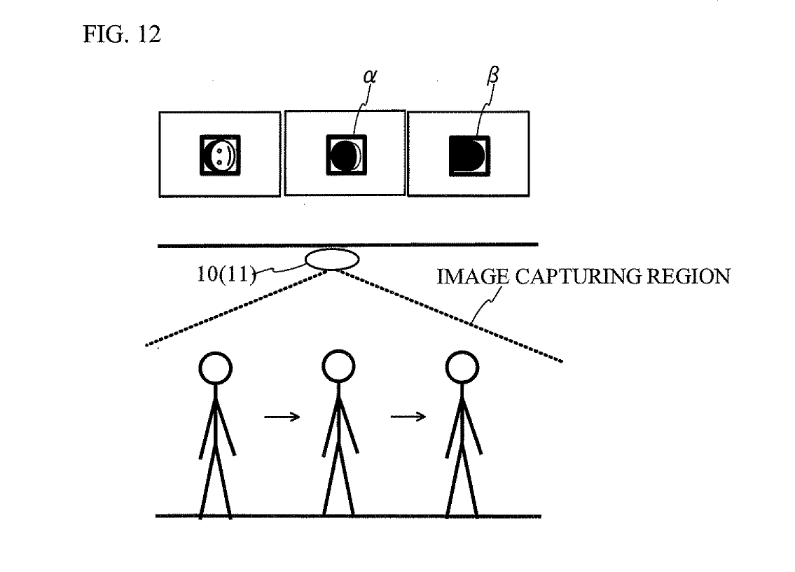

A description will next be given of a tracking process by a single image capturing device 11 immediately after the subject person enters the office with reference to FIG. 12. After the subject person enters the office, the control unit 25 starts to continuously acquire images with the image capturing devices 11 as illustrated in FIG. 12. Then, the control unit 25 performs pattern matching between the continuously acquired images and the reference template (or composite template) to extract the portion (head portion) of which the score value is greater than a given reference value, and calculates the position of the subject person (the height position and the two-dimensional position in a floor surface) from the extracted portion. In this case, assume that the score value becomes greater than the given reference value at the time when the image a in FIG. 12 is acquired. Therefore, the control unit 25 determines the position of the image a in FIG. 12 to be the position of the subject person, sets the image α as the reference template, and generates composite templates of the new reference template.

Then, the control unit 25 tracks the head of the subject person using the new reference template (or composite template), and sets the acquired image (e.g. the image β in FIG. 12) as a new reference template and generates composite templates (updates the reference template and composite templates) every time the position of the subject person changes. There may be a case where the size of the head suddenly becomes small while the tracking process is performed as described above. That is to say, there may be a case where the scale factor of the composite template used for pattern matching greatly changes. In such a case, the control unit 25 may determine that a trouble such as falling down of the subject person occurs.

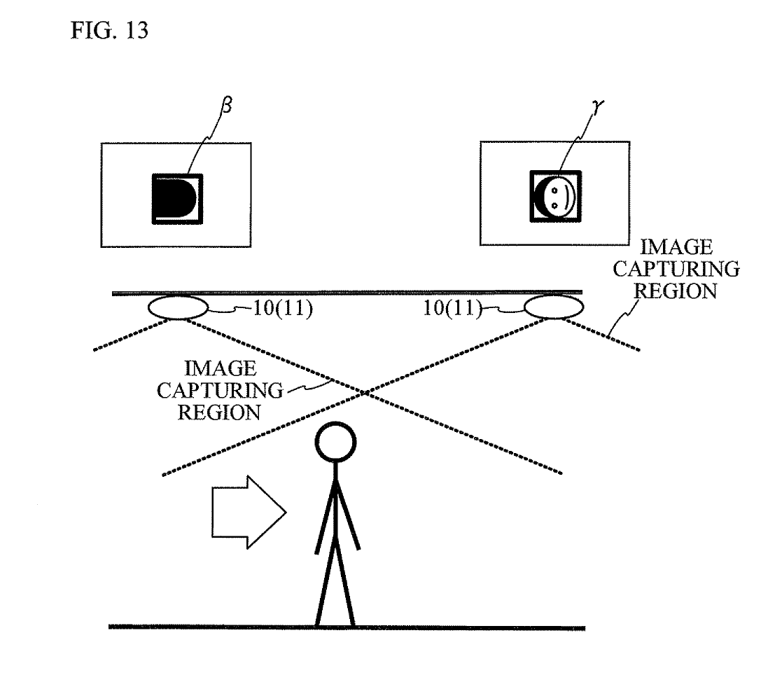

A description will next be given of a liaison process between two image capturing devices 11 (a change process of the reference template and the composite templates) with reference to FIG. 13.

Assume that the control unit 25 detects the position of the head of the subject person with a first image capturing device 11 (at the left side) in a state where the subject person is positioned between two image capturing devices 11 (in the overlapping region of the image capturing regions described previously). Assume that the reference template at this time is the image β in FIG. 13. In this case, the control unit 25 calculates in which position of the image capturing region of a second image capturing device 11 (at the right side) the image of the head is captured based on the position of the head of the subject person. Then, the control unit 25 sets an image of a position in which the image of the head is to be captured in the image capturing region of the second image capturing device 11 (at the right side) (the image γ in FIG. 13) as a new reference template, and generates composite templates. In the tracking process using the image capturing device 11 at the right side thereafter, the tracking process described in FIG. 12 is performed while the reference template (image γ) is updated.

The above described process enables to track the subject person in the office by updating the reference template as needed.

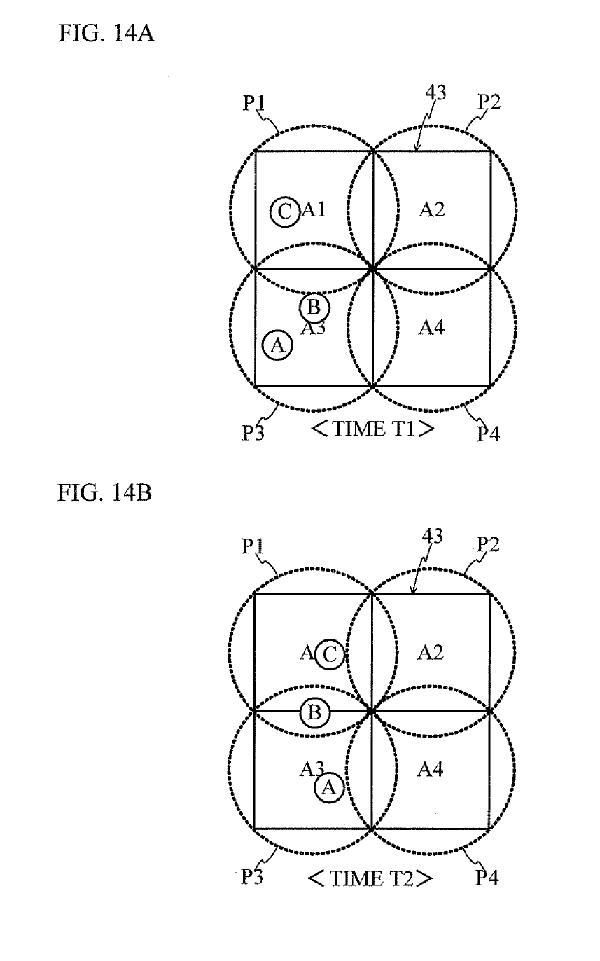

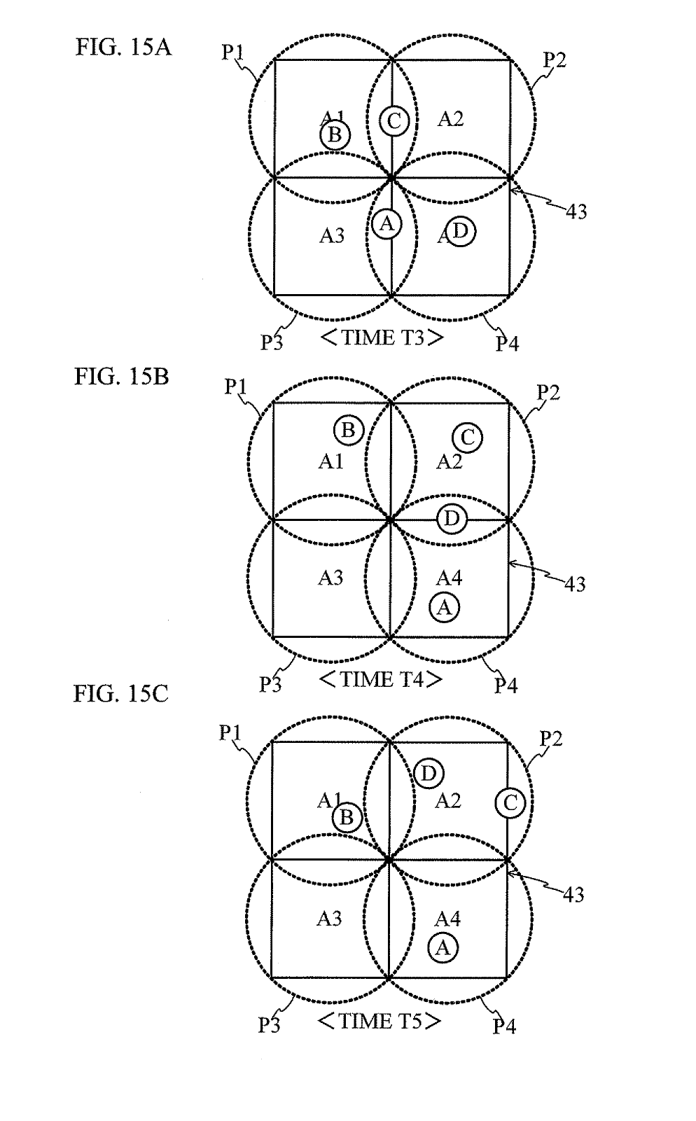

A description will next be given of the tracking process in a case where four subject persons (subject persons A, B, C, D) move around in one section 43 in FIG. 10 with reference to FIG. 14 and FIG. 15. The control unit 25 updates the reference template as needed during the tracking process as described in FIG. 12 and FIG. 13.

FIG. 14A illustrates a state at time T1. FIG. 14B through FIG. 15C illustrate states after time T1 (time T2 through T5).

At time T1, the subject person C is present in the divided area A1, and the subject persons A, B are present in the divided area A3. In this case, the image capturing device 11 with the image capturing region P1 captures the image of the head of the subject person C, and the image capturing device 11 with the image capturing region P3 captures the images of the heads of the subject persons A, B.

At time T2, the image capturing device 11 with the image capturing region P1 captures the images of the heads of the subject persons B, C, and the image capturing device 11 with the image capturing region P3 captures the images of the heads of the subject persons A, B.

In this case, the control unit 25 recognizes that the subject persons A, C move in the horizontal direction of FIG. 14 and the subject person B moves in the vertical direction of FIG. 14B from the image capturing results of the image capturing devices 11 at time T1, T2. The reason why the image of the subject person B is captured by two image capturing devices 11 at time T2 is because the subject person B is present in the overlapping region of the image capturing regions of two image capturing devices 11. In the state illustrated in FIG. 14B, the control unit 25 performs the liaison process illustrated in FIG. 13 (the change process of the reference template and the composite templates between two image capturing devices 11) for the subject person B.

At time T3, the image capturing device 11 with the image capturing region P1 captures the images of the heads of the subject persons B, C, the image capturing device 11 of the image capturing region P2 captures the image of the head of the subject person C, and the image capturing device 11 with the image capturing region P3 captures the image of the head of the subject person A, and the image capturing device 11 with the image capturing region P4 captures the images of the heads of the subject persons A, D.

In this case, the control unit 25 recognizes that the subject person A is present in the boundary between the divided area A3 and the divided area A4 (moving from the divided area A3 to the divided area A4), the subject person B is present in the divided area A1, the subject person C is present in the boundary between the divided area A1 and the divided area A2 (moving from the divided area A1 to A2), and the subject person D is present in the divided area A4 at time T3 (FIG. 15A). In the state illustrated in FIG. 15A, the control unit 25 performs the liaison process illustrated in FIG. 13 (the change process of the reference template and the composite template between two image capturing devices 11) for the subject persons A and C.

In the same manner, the control unit 25 recognizes that the subject person A is present in the divided area A4, the subject person B is present in the divided area A1, the subject person C is present in the divided area A2, and the subject person D is present between the divided areas A2 and A4 at time T4 (FIG. 15B). In the state illustrated in FIG. 15B, the control unit 25 performs the liaison process illustrated in FIG. 13 (the change process of the reference template and the composite template between two image capturing devices 11) for the subject person D. In addition, the control unit 25 recognizes that the subject person A is present in the divided area A4, the subject person B is present in the divided area A1, the subject person C is present in the divided area A2, and the subject person D is present in the divided area A2 at time T5 (FIG. 15C).

The present embodiment configures the image capturing regions of the image capturing devices 11 to overlap each other as described above, and thereby allows the control unit 25 to recognize the position and the moving direction of the subject person. As described above, the present embodiment allows the control unit 25 to continuously track each subject person in the office with a high degree of accuracy.

A description will next be given of a method of controlling the directional loudspeaker 13 by the control unit 25 with reference to FIG. 16. FIG. 16 illustrates the guidance units 10 arranged along the passageway (hallway), and regions defined by chain lines mean the image capturing regions of the image capturing devices 11 included in the guidance units 10. The image capturing regions of the adjoining image capturing devices 11 overlap each other in the case illustrated in FIG. 16.

In the present embodiment, the control unit 25 guides the subject person by voice using the directional loudspeaker 13 of the guidance unit 10a (see the bold solid arrow extending from the guidance unit 10a) when the subject person is present at position K1 in a case where the subject person moves from position K1 toward position K4 (+X direction) as illustrated in FIG. 16.

On the other hand, the control unit 25 guides the subject person by voice using the directional loudspeaker 13 of the guidance unit 10b having the image capturing device 11 that is not capturing the image of the subject person (see the bold solid line arrow extending from the guidance unit 10b) instead of the guidance unit 10a having the image capturing device 11 that is capturing the image of the subject person (see the bold dashed line arrow extending from the guidance unit 10a) when the subject person is present at position K2.

The reason why the directional loudspeaker 13 is controlled in the above described manner is because the subject person is guided by voice from the back of his/her ears if the control unit 25 guides the person by voice from the directional loudspeaker 13 of the guidance unit 10 while the subject person can be guided by voice from the front side of his/her ears if the control unit 25 controls the position of the directional loudspeaker 13 of the guidance unit 10b and guides the subject person when the subject person moves to +X direction. That is to say, the selection of the directional loudspeaker 13 located on more positive side in the X direction than the subject person enables to guide the subject person by voice from the front of the face when the subject person is moving to +X direction. The control unit 25 may select the directional loudspeaker 13 so as to guide the subject person by voice from his/her side. That is to say, it is sufficient if the control unit 25 selects the directional loudspeaker 13 so that the subject person is not guided by voice from the back of his/her ears.

The control unit 25 guides the subject person by voice using the directional loudspeaker 13 of the guidance unit 10b when the subject person is present at position K3. Further, the control unit 25 guides the subject person by voice using the directional loudspeaker 13 of the guidance unit 10d when the subject person is present at position K4. The reason why the directional loudspeaker 13 is controlled in the above described manner when the subject person is present at position K4 is because a non-subject person around the subject person may hear the voice guidance if the subject person is guided by voice with the directional loudspeaker 13 of the guidance unit 10c (see the bold dashed line arrow extending from the guidance unit 10c) at position K4. When two or more persons are around the subject person or the directional loudspeaker 13 has difficulty in following the subject person for some reason, the control unit 25 may temporarily suspend the voice guidance, and resume the voice guidance later. When resuming the voice guidance, the control unit 25 may back to the time a given time before the suspension (e.g. a few seconds before the suspension) before resuming the voice guidance.

In addition, the number of the directional loudspeakers 13 located may be increased, and they may be used as directional loudspeakers for a right ear and directional loudspeakers for a left ear in accordance with the position of the subject person. In this case, the control unit 25 performs the voice guidance with the directional loudspeaker for a right ear when it is determined that the subject person is telephoning with a mobile phone to his/her left ear by the image capturing by the image capturing device 11.

In the present embodiment, the control unit 25 selects the directional loudspeaker 13 with which the voice guidance is unlikely to be heard by a non-subject person based on the image capturing result of at least one image capturing device 11 as described above. Even when a non-subject person is present near the subject person as in a case of position K4, the subject person may ask questions through the directional microphone 12. In such a case, the sound of the word from the subject person may be collected with the directional microphone 12 of the guidance unit 10c capturing the image of the subject person (the directional microphone 12 located closest to the subject person). Alternatively, the control unit 25 may collect the sound of the word from the subject person with the directional microphone 12 located in front of the mouth of the subject person.

The guidance unit 10 may be activated (powered on) as needed. For example, the guidance unit 10a captures an image of a visitor, and the guidance unit 10b adjacent to the guidance unit 10a may be activated at the time when it is determined that the visitor moves to +X side in FIG. 16. In this case, it is sufficient if the guidance unit 10b is activated before the visitor comes to the overlapping region between the image capturing region of the image capturing device 11 of the guidance unit 10a and the image capturing region of the image capturing device 11 of the guidance unit 10b. In addition, the guidance unit 10a may shut the power off or enters an energy saving mode (standby mode) at the time when an image of the visitor is not captured.

The voice unit 50 illustrated in FIG. 2 may include a drive mechanism enabling to drive the unit body 16 in the X-axis direction and the Y-axis direction. In this case, the number of the directional loudspeakers 13 (voice units 50) can be reduced by changing the position of the directional loudspeaker 13 through the drive mechanism so that the voice can be emitted from the front (or side) of the subject person, or changing the position of the directional loudspeaker 13 at which a non-subject person cannot hear the voice.

FIG. 16 illustrates the guidance units 10 arranged along a single-axis direction (X-axis direction), but the guidance units 10 may be additionally arranged along the Y-axis direction to perform the same control.

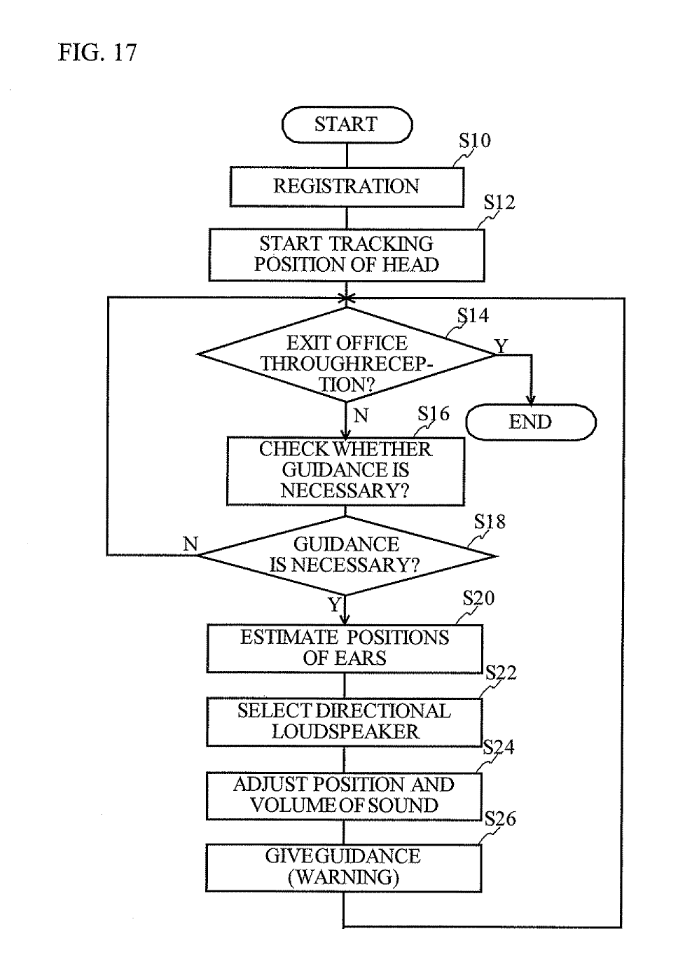

A detailed description will next be given of a process and operation of the guidance system 100 of the present embodiment with reference to FIG. 17. FIG. 17 is a flowchart illustrating a process of guiding a subject person by the control unit 25. The present embodiment describes the guidance process when a visitor (subject person) comes to the office.

In the process illustrated in FIG. 17, the control unit 25 executes a registration process at step S10. More specifically, the control unit 25 captures an image of the visitor by the image capturing device 11 of the guidance unit 10 located on the ceiling around a reception when the visitor comes to the reception (see FIG. 11), and generates a reference template and composite templates. In addition, the control unit 25 recognizes an area into which the visitor is permitted to enter based on preliminarily registered information, and provides a meeting place from the directional loudspeaker 13 of the guidance unit 10 around the reception. In this case, the control unit 25 synthesizes voice for the voice guidance such as “XX, who is a person in charge, is waiting for you at the fifth reception room. Please go down the hallway.” by the voice synthesis unit 23, and emits the voice from the directional loudspeaker 13.

At step S12, the control unit 25 captures an image of the head of the visitor with the image capturing devices 11 of the guidance units 10 to track the visitor as described in FIG. 12 through FIG. 15. In this case, the reference template is updated as needed, and the composite templates are also generated as needed.

At step S14, the control unit 25 determines whether the visitor exits the office through the reception. The entire process in FIG. 17 is ended when the determination here is Yes, while the process moves to step S16 when the determination here is No.

At step S16, it is determined whether the guidance for the visitor is necessary. In this case, the control unit 25 determines that the guidance for the visitor is necessary when the visitor is approaching a branch point on the way to the fifth reception room (a location at which the visitor needs to walk to the right). In addition, the control unit 25 determines that the guidance is necessary when the visitor asks a question such as “Where is a bathroom?” to the directional microphone 12 of the guidance unit 10 for example. Moreover, the control unit 25 determines that the guidance is necessary when the visitor stops for a given time period (e.g. 3 to 10 seconds).

At step S18, the control unit 25 determines whether the guidance is necessary. The process goes back to step S14 when the determination at step S18 is No, while the process moves to step S20 when the determination at step S18 is Yes.

At step S20, the control unit 25 estimates the positions of the ears (the position of the front side of the face) while checking the moving direction of the visitor based on the image capturing result of the image capturing device 11. The positions of the ears can be estimated from the height associated with the person (subject person) identified at the reception. When the height is not associated with the subject person, the positions of the ears may be estimated based on the size of the head of which the image was captured at the reception, or the height calculated from the image of the subject person captured from the front at the reception.

At step S22, the control unit 25 selects the directional loudspeaker 13 to emit the voice based on the position of the visitor. In this case, the control unit 25 selects the directional loudspeaker 13 located in front of or at the side of the ears of the subject person and in the direction in which a non-subject person near the subject person is unlikely to hear the voice guidance as described in FIG. 16.

At step S24, the control unit 25 adjusts the position of the directional microphone 12 and the directional loudspeaker 13 by the drive device 14, and sets the volume (output) of the directional loudspeaker 13. In this case, the control unit 25 detects the distance between the visitor and the directional loudspeaker 13 of the guidance unit 10b based on the image capturing result of the image capturing device 11 of the guidance unit 10a, and sets the volume of the directional loudspeaker 13 based on the detected distance. The control unit 25 also adjusts the positions of the directional microphone 12 and the directional loudspeaker 13 in the tilt direction by the motor 14a (see FIG. 3) when determining that the visitor is going straight based on the image capturing result of the image capturing device 11. Further, the control unit 25 adjusts the positions of the directional microphone 12 and the directional loudspeaker 13 in the pan direction by the motor 14b (see FIG. 3) when determining that the visitor turns the hallway based on the image capturing result of the image capturing device 11.

At next step S26, the control unit 25 guides or warns the visitor in the adjusted state at step S24. More specifically, the voice guidance such as “Please turn right.” is performed when the visitor reaches a branch point at which the visitor needs to turn right for example. In addition, when the visitor emits the voice such as “Where is a bathroom?” for example, the control unit 25 makes the sound recognition unit 22 recognize the sound input from the directional microphone 12, and makes the voice synthesis unit 23 synthesize the voice to provide the position of the closest bathroom in the area to which the visitor is permitted to enter. The control unit 25 outputs the voice synthesized by the voice synthesis unit 23 from the directional loudspeaker 13. In addition, when the visitor enters (or is likely to enter) the area to which the visitor is not permitted to enter (security area), the control unit 25 performs the voice guidance (warning) such as “Do not enter this area.” from the directional loudspeaker 13. The present embodiment employs the directional loudspeaker 13, and thus the voice guidance with the directional loudspeaker 13 enables to appropriately guide only the person who needs the voice guidance.

After the process at step S26 is ended as described above, the process goes back to step S14. The above described process is repeated till the visitor exits the office through the reception. The above described process enables to save someone the trouble of guiding a visitor even when the visitor comes to the office and to prevent the visitor from entering a security area or the like. In addition, the visitor is not necessary to hold a sensor, and thus the visitor does not feel bothered.

As described above in detail, the present embodiment configures the control unit 25 to acquire an image capturing result from at least one image capturing device 11 capable of capturing an image containing a subject person and control the directional loudspeaker 13 located outside the image capturing region of the image capturing device 11 in accordance with the acquired image capturing result. This configuration allows the subject person to easily hear the voice emitted from the directional loudspeaker by outputting the voice from the directional loudspeaker 13 located outside the image capturing region even in a case where the subject person cannot hear the voice clearly because the voice is to be emitted from the back of the ear of the subject person if the voice is output from the directional loudspeaker 13 located in the image capturing region of the image capturing device 11. In addition, when a non-subject person is present near the subject person and the non-subject person is likely to hear the voice, the voice can be prevented from being heard by the non-subject person by outputting the voice from the directional loudspeaker 13 located outside the image capturing region. That is to say, the control of the appropriate directional loudspeaker 13 becomes possible. The present embodiment describes a case where the subject person is moving, but can be applied to a case where he/she changes a direction of the face and a case where he/she changes his/her posture.

Moreover, the present embodiment configures the control unit 25 to detect move information (position or the like) of the subject person based on the image capturing result of at least one image capturing device 11 and control the directional loudspeaker 13 based on the detection result, and thus allows it to control the appropriate directional loudspeaker 13 in accordance with the move information (position or the like) of the subject person.

In addition, the present embodiment configures the control unit 25 to warn the subject person from the directional loudspeaker 13 when determining that the subject person moves outside a predetermined area (outside a security area) based on the move information of the subject person or has moved outside the predetermined area (outside a security area). This configuration enables to prevent the subject person from moving outside the security area without using a person.

Moreover, the present embodiment configures the control unit 25 to control the directional loudspeaker 13 when the image capturing device 11 captures an image of a person other than the subject person, and thus allows it to control the appropriate directional loudspeaker so that the person other than the subject person (non-subject person) does not hear the voice.

Moreover, the present embodiment configures the drive device 14 to adjust the position and/or attitude of the directional loudspeaker 13, and thus enables to adjust the voice emitting direction of the directional loudspeaker 13 to an appropriate direction (the direction in which the subject person can hear the voice easily).

In addition, the present embodiment configures the drive device 14 to adjust the position and/or attitude of the directional loudspeaker 13 in accordance with the move of the subject person, and thus enables to appropriately control the voice emitting direction of the directional loudspeaker 13 even though the subject person moves.

Moreover, the present embodiment arranges the adjoining image capturing devices 11 so that the image capturing regions of the adjoining image capturing devices 11 overlap each other, and thus enables to track the subject person using the adjoining image capturing devices 11 even when the subject person moves across the image capturing regions of the adjoining image capturing devices 11.

In addition, the present embodiment configures the control unit 25 to set the image of the head portion captured by the image capturing device 11 as a reference template, identify the head portion of the subject person using the reference template when tracking the subject person, and update the reference template with a new image of the identified head portion. Therefore, the control unit 25 can appropriately track the moving subject person by updating the reference template even when the image of the head changes.

Moreover, the present embodiment configures the control unit 25, when the image of the subject person can be simultaneously captured by two or more image capturing devices, to acquire position information of the head portion of the subject person whose image is captured by a first image capturing device and set an image of a region in which the head portion is present out of an image captured by a second image capturing device other than the first image capturing device as a reference template for the second image capturing device. Thus, even when the images of the head portion acquired by the first image capturing device and the second image capturing device differ from each other (e.g. the image β of the back of the head and the image γ of the front of the head), appropriate tracking of the subject person using two or more image capturing devices becomes possible by determining the reference template as described above.

Moreover, the present embodiment configures the control unit 25 to determine that a trouble has happened to the subject person when information of the size of the head portion changes more than a given amount, and thus enables to find out the trouble (falling down) of the subject person while protecting the privacy.

Moreover, the present embodiment configures the control unit 25 to acquire the image capturing result of the image capturing device 11 capable of capturing an image containing a subject person, adjust a position and/or attitude of the directional loudspeaker 13 based on a detection result of size information (positions of ears, height, a distance from the image capturing device 11) of the subject person from the acquired image capturing result, and thus allows it to appropriately control the position and attitude of the directional loudspeaker 13. This allows the voice emitted to the subject person from the directional loudspeaker 13 to be heard easily. There may be a case where high frequency sounds (e.g. sounds of 4000 to 8000 Hz) are difficult to be heard with age. In such a case, the control unit 25 may set the frequency of the sound emitted from the directional loudspeaker 13 to the frequency at which the voice is easily heard (e.g. a frequency around 2000 Hz), or convert it before emitting. The guidance system 100 may be used in place of a hearing aid. Japanese Patent No. 4913500 discloses the conversion of the frequency, for example.

In addition, the present embodiment configures the control unit 25 to set the output (volume) of the directional loudspeaker based on the distance between the subject person and the image capturing device 11, and thus allows the sound output to the subject person from the directional loudspeaker 13 to be heard easily.

In addition, the present embodiment configures the control unit 25 to perform the voice guidance with the directional loudspeaker 13 in accordance with the position of the subject person, and thus allows it to perform an appropriate guidance (or warning) when the subject person is present at a branch point or in or around a security area.

Moreover, the present embodiment configures the control unit 25 to correct the size information of the subject person based on the positional relationship between the subject person and the image capturing device 11, and thus enables to suppress the occurrence of the detection error due to the effect of the distortion of the optical system in the image capturing device 11.

In the above described embodiment, the image capturing device 11 captures an image of the head portion of the subject person, but may capture an image of a shoulder of the subject person. In this case, the positions of the ears may be estimated from the height of the shoulder.

In addition, the above described embodiment describes a case where the directional microphone 12 and the directional loudspeaker 13 are unitized, but does not intend to suggest any limitation, and the directional microphone 12 and the directional loudspeaker 13 may be separately provided. In addition, a microphone without directionality (e.g. a zoom microphone) may be employed instead of the directional microphone 12, and a loudspeaker without directionality may be employed instead of the directional loudspeaker 13.

In addition, the above described embodiment installs the guidance system 100 in an office, and performs the guidance process when a visitor comes to the office, but does not intend to suggest any limitation. For example, the guidance system 100 may be installed in a sales floor in a supermarket or a department store, and the guidance system 100 may be used to guide customers to a selling space or the like. In the same manner, the guidance system 100 may be installed in a hospital. In this case, the guidance system 100 may be used to guide a patient. For example, when several exams are carried out in a complete medical checkup for example, the subject person can be guided and the efficiency of a diagnostic task, an accounting task, and the like can be promoted. In addition, the guidance system 100 of the above described embodiment can be applied to the voice guidance to visually-impaired people and a hands-free phone. Further, the guidance system 100 can be used for the guidance in places such as museums, movie theaters, and concert halls to be quiet. Further, a non-subject people is unlikely to hear the voice guidance, and thus the personal information of the subject person can be protected. When an attendant is present in a place in which the guidance system 100 is installed, it guides the subject person who needs the guidance by voice and informs the attendant that the subject person who needs the guidance is present. In addition, the guidance system 100 of the present embodiment can be applied to the noisy place such as in a train. In this case, when the phase of the noise is inverted and the inverted sound is output from the directional loudspeaker to the subject person, the trouble in hearing the voice guidance due to the noise can be reduced. The noise may be collected by a microphone with directionality or without directionality.

The above described embodiment locates the card reader 88 at a reception of an office, and identifies a person who is to enter the office, but does not intend to suggest any limitation, and may identify a person with a biometrics device using fingerprints or voices, or a passcode input device.

While the exemplary embodiments of the present invention have been illustrated in detail, the present invention is not limited to the above-mentioned embodiments, and other embodiments, variations and modifications may be made without departing from the scope of the present invention.

1. An electronic device comprising:
an acquisition device that acquires an image capturing result from at least one image capturing device that is capable of capturing an image containing a first person;
a controller configured to control a voice device located outside an image capturing region of the image capturing device in accordance with the image capturing result of the image capturing device.

2. The electronic device according to claim 1, further comprising:
a detector configured to detect move information of the first person based on the image capturing result of the at least one image capturing device, wherein
the controller the voice device based on a detection result of the detector.

3. The electronic device according to claim 2, wherein
the controller controls the voice device to warn the first person when determining that the first person moves outside a predetermined area or has moved outside a predetermined area based on the move information detected by the detector.

4. The electronic device according to claim 1, wherein
the controller controls the voice device when the at least one image capturing device captures an image of a second person other than the first person.

5. The electronic device according to claim 1, wherein
the voice device includes a directional loudspeaker.

6. The electronic device according to claim 1, further comprising:
a driver configured to adjust a position and/or attitude of the voice device.

7. The electronic device according to claim 6, wherein
the driver adjusts the position and/or attitude of the voice device in accordance with a move of the first person.

8. The electronic device according to claim 1, wherein
the at least one image capturing device includes a first image capturing device and a second image capturing device,
the first and second image capturing devices are arranged so that a part of an image capturing region of the first image capturing device overlaps a part of an image capturing region of the second image capturing device.

9. The electronic device according to claim 8, wherein
the voice device includes a first voice device located in the image capturing region of the first image capturing device and a second voice device located in the image capturing region of the second image capturing device, and
the controller controls the second voice device when the first voice device is positioned at a back side of the first person.

10. The electronic device according to claim 8, wherein
the voice device includes a first voice device including a first loudspeaker located in the image capturing region of the first image capturing device and a second voice device including a second loudspeaker located in the image capturing region of the second image capturing device, and
the controller controls the second loudspeaker when the first image capturing device captures an image of the person and an image of a person other than the first person.

11. The electronic device according to claim 10, wherein
the first voice device includes a microphone, and
the controller controls the microphone to collect voice of the first person when the first image capturing device captures an image of the first person.

12. The electronic device according to claim 1, further comprising:
a tracking device configured to track the first person using the image capturing result of the image capturing device, wherein
the tracking device acquires an image of a specific portion of the first person using the image capturing device, sets the image of the specific portion as a template, identifies the specific position of the first person using the template when tracking the person, and updates the template with a new image of the specific portion of the identified first person.

13. The electronic device according to claim 12, wherein
the image capturing device includes a first image capturing device and a second image capturing device having an image capturing region overlapping a part of an image capturing region of the first image capturing device, and
the tracking device acquires, when the first image capturing device and the second image capturing device simultaneously capture images of the first person, positional information of the specific portion of the first person whose image is captured by one of the image capturing devices, and identifies a region corresponding to the positional information of the specific portion in an image captured by the other of the image capturing devices and sets an image of the identified region as the template for the other of the image capturing devices.

14. The electronic device according to claim 12 wherein
the tracking device determines that a trouble has happened to the first person when size information of the specific portion changes more than a given amount.

15. An information transmission system comprising:
at least one image capturing device that is capable of capturing an image containing a first person;
a voice device located outside an image capturing region of the image capturing device; and
an electronic device according to claim 1.

16. An electronic device comprising:
an acquisition device configured to acquire an image capturing result of an image capturing device that is capable of capturing an image containing a first person;
a first detector configured to detect size information of the first person from the image capturing result of the image capturing device; and
a driver configured to adjust a position and/or attitude of a voice device with directionality based on the size information detected by the first detector.

17. The electronic device according to claim 16, further comprising:
a detector configured to detect positions of ears of the first person based on the size information detected by the first detector.

18. The electronic device according to claim 17, wherein
the driver adjusts the position and/or attitude of the voice device with directionality based on the positions of the ears detected by the second detector.

19. The electronic device according to claim 16, further comprising:
a setting device configured to set an output of the voice device with directionality based on the size information detected by the first detector.

20. The electronic device according to claim 16, further comprising:
a controller configured to control a voice guidance by the voice device with directionality in accordance with a position of the first person.

21. The electronic device according to claim 16, wherein
the driver adjusts the position and/or attitude of the voice device with directionality in accordance with a move of the first person.

22. The electronic device according to claim 16, wherein
the voice device with directionality is located near the image capturing device.

23. The electronic device according to claim 16, further comprising:
a correcting device configured to correct the size information of the first person detected by the first detector based on a positional relationship between the first person and the image capturing device.

24. The electronic device according to claim 16, further comprising:
a tracking device configured to track the first person using the image capturing result of the image capturing device, wherein
the tracking device acquires an image of a specific portion of the first person using the image capturing device and sets an image of the specific portion as a template, and identifies the specific position of the first person using the template when tracking the first person and updates the template with a new image of the specific portion of the identified first person.

25. The electronic device according to claim 24, wherein
the image capturing device includes a first image capturing device and a second image capturing device having an image capturing region overlapping a part of an image capturing region of the first image capturing device, and
the tracking device acquires, when the first image capturing device and the second image capturing device simultaneously capture images of the first person, positional information of the specific portion of the first person whose image is captured by one of the image capturing devices, and identifies a region corresponding to the positional information of the specific portion in an image captured by the other of the image capturing devices and sets an image of the identified region as the template for the other of the image capturing devices.

26. The electronic device according to claim 24, wherein
the tracking device determines that a trouble has happened to the first person when the size information of the specific portion changes more than a given amount.

27. An information transmission system comprising:
at least one image capturing device that is capable of capturing an image containing a first person;
a voice device with directionality; and
an electronic device according to claim 16.

28. An electronic device comprising:
an ear detector configured to detect positions of ears of a first person; and
a driver configured to adjust a position and/or attitude of a voice device with directionality based on a detection result of the ear detector.

29. The electronic device according to claim 28, wherein
the ear detector includes an image capturing device capturing an image of the first person, and detects the positions of the ears of the first person from information relating to a height of the first person based on the captured image by the image capturing device.

30. The electronic device according to claim 28, wherein
the ear detector detects the positions of the ears from a moving direction of the first person.

31. An electronic device comprising:
a position detector configured to detect a position of a first person; and
a selecting device configured to select at least one directional loudspeaker from directional loudspeakers based on a detection result of the position detector.

32. The electronic device according to claim 31, further comprising:
a driver configured to adjust a position and attitude of the directional loudspeaker selected by the selecting device.

33. The electronic device according to claim 32, wherein
the driver adjusts the position and/or attitude of the directional loudspeaker toward the ears of the first person.
